(19) United States
(12) Patent Application Publication
(10) Pub. No.: US 2004/0157576 A1
(43) Pub. Date: Aug. 12, 2004

(54) Communication device performing communication using two clock signals complementary to each other

(75) Inventors: Kiyoshi Adachi, Hyogo (JP); Danichi Komatsu, Hyogo (JP); Takashi Utsumi, Hyogo (JP); Yoshiyuki Haraguchi, Hyogo (JP); Hiroyuki Kousaka, Hyogo (JP); Masahiro Yokoyama, Hyogo (JP)

Correspondence Address: BURNS DOANE SWECKER & MATHIS L L P, POST OFFICE BOX 1404, ALEXANDRIA, VA, 22313-1404, US

(73) Assignee: RENESAS TECHNOLOGY CORP.

(21) Appl. No.: 10/715,518

(22) Filed: Nov. 19, 2003

(30) Foreign Application Priority Data
Feb. 12, 2003 (JP) 2003-033765(P)

(51) Int. Cl. H04B 1/06

(52) U.S. Cl. 455/260; 455/257

(57) ABSTRACT

A receiver of a communication device includes: a differential amplification circuit; two capacitors for applying only the amplitude components of two input clock signals complementary to each other to the gates of two N-channel MOS transistors of the differential amplification circuit; and an initialization circuit for applying a predetermined reference potential to the gates of the two N-channel MOS transistors in a non data communication state. Thus, it is possible to make a quick and stable transition from a non data communication state to a data communication state.

### BACKGROUND OF THE INVENTION

1. Field of the Invention

The present invention relates to a communication device and, more particularly, to a communication device performing communication using first and second clock signals complementary to each other.

2. Description of the Background Art

In a communication device, when data are communicated between communication devices by using only a data signal line without using a special signal line for transmitting a control signal or clock signal, a signal indicative of the start of communication is transmitted and received over the data signal line. The transmission speed and leading position of a data signal are not determined until the start of communication, which makes it necessary to employ a communication method different from ordinary data communication, including the initialization of a communication sequence at the start of communication.

In some conventional communication devices, a squelch signal indicative of a non data communication state and a data signal in a data communication state are transmitted alternately at fixed time intervals at the start of communication to initialize the communication sequence, thereby adjusting synchronization timing (see “6.7.4.2 COMRESET” Serial ATA: High Speed Serialized AT Attachment Revision 1.0, pp.91-92, Aug. 29, 2001 by Serial ATA Workgroup (U.S.A.); hereafter, it is referred as Document 1.). In this case, even when data are not communicated, the communication device is operated to monitor the squelch signal. When the system is initialized or transferred to a low power consumption state, the system is initialized or suspended by using a system reset signal or a control signal.

There is a communication control semiconductor device capable of suppressing power consumption in a reception standby state without deteriorating a receiving performance at the time of data reception, by making the receiver control device determine between a receiving state and a reception standby state on the basis of data that receivers receive and by using a quick-responding receiver in the receiving state and a slow-responding receiver in the reception standby state (see Japanese Patent Laying-Open No. 6-132987, for example).

There is another device which compares a current indicated by a measurement signal with a threshold current which is an intermediate value between the maximum value and minimum value of the current indicated by the measurement signal in a transceiver, so as to suspend a power supply to the transceiver in a non data communication state, thereby realizing power consumption reduction (see Japanese Patent Laying-Open No. 5-91157, for example).

There is also a system for monitoring faults in a digital device including a living device and a backup device, in which the fault monitoring of the backup device is operated by a lower-speed clock signal than the fault monitoring of the living device so as to realize power consumption reduction (see Japanese Patent Laying-Open No. 6-54032, for example).

However, in the method described in Document 1, the squelch signal indicative of a non data communication state is used only as a signal informing the reception state before the start of data communication. In other words, the system is controlled by a system reset signal or control signal without using the squelch signal as a signal for controlling the system directly, so that it takes time to make a transition from a non data communication state to a data communication state.

The methods described in Japanese Patent Laying-Open Nos. 6-132987 and 5-91157 have an object of realizing power consumption reduction in the receivers and the transceivers at the time when data are not communicated, and the method described in Japanese Patent Laying-Open No. 6-54032 has an object of realizing power consumption reduction by operating the fault monitoring of the backup device by a low-speed clock signal.

### SUMMARY OF THE INVENTION

It is therefore a main object of the present invention to provide a communication device capable of making a quick and stable transition from a non data communication state to a data communication state.

A communication device according to the present invention includes: a squelch detection circuit for determining the communication device as being in a data communication state to output a first signal when received first and second clock signals have a potential amplitude larger than a predetermined value, and for determining the communication device as being in a non data communication state to output a second signal when the received first and second clock signals have a potential amplitude not more than the predetermined value; and an initialization circuit for initializing the communication device when the second signal is outputted from the squelch detection circuit. Consequently, in a non data communication state, the initialization circuit initializes the communication device according to the second signal outputted from the squelch detection circuit, thereby making it possible to make a quick and stable transition from a non data communication state to a data communication state.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a communication device according to a first embodiment of the present invention;

FIGS. 2A and 2B are waveform charts for describing a communication method of the communication device shown in FIG. 1;

FIG. 3 is a circuit diagram showing the structure of a receiver shown in FIG. 1;

FIGS. 4A to 4C are diagrams for describing the amplification characteristic of a differential amplification circuit shown in FIG. 3;

FIGS. 5A and 5B are another diagrams for describing the amplification characteristic of the differential amplification circuit shown in FIG. 3;

FIG. 6 is a block diagram showing the structure of a reception PLL circuit shown in FIG. 1;

FIG. 7 is a circuit diagram showing the structure of a charge pump, loop filter and initialization circuit shown in FIG. 6;

FIG. 8 is a block diagram showing the structure of a reception PLL circuit according to a second embodiment of the present invention; and

FIG. 9 is a block diagram showing a modification of the second embodiment.

### DESCRIPTION OF THE PREFERRED EMBODIMENT

First Embodiment

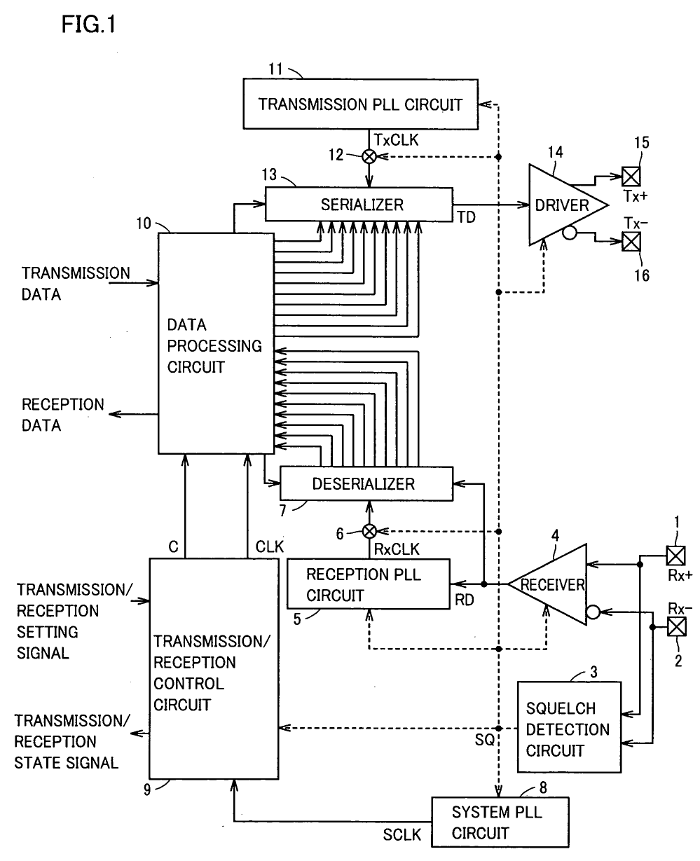

FIG. 1 is a block diagram showing the structure of a communication device according to a first embodiment of the present invention. In FIG. 1 the communication device includes input terminals 1, 2, a squelch detection circuit 3, a receiver 4, a reception PLL (Phase Locked Loop) circuit 5, switch circuits 6, 12, a deserializer 7, a system PLL circuit 8, a transmission/reception control circuit 9, a data processing circuit 10; a transmission PLL circuit 11, a serializer 13, a driver 14 and output terminals 15, 16.

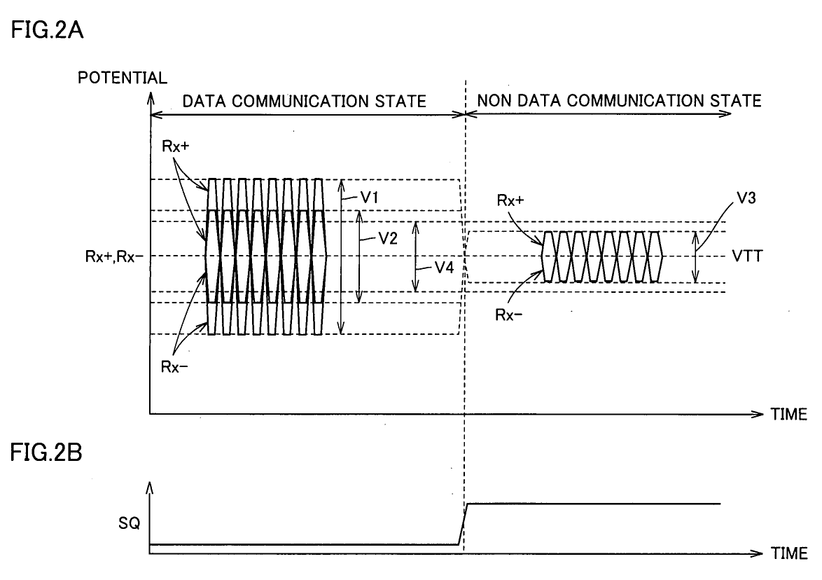

Input terminals 1, 2 receive signals Rx+, Rx− from outside. Squelch detection circuit 3 detects the magnitude of the potential amplitude of signals Rx+, Rx− inputted to input terminals 1, 2, and outputs a squelch signal SQ on the basis of the detection results. FIGS. 2A and 2B are waveform charts showing the relationship between input signals Rx+, Rx− of squelch detection circuit 3 and squelch signal SQ outputted from squelch detection circuit 3, respectively. In FIGS. 2A and 2B the horizontal axis indicates time and the vertical axis indicates potential.

Signals Rx+ and Rx− are complementary clock signals whose potentials fluctuate around a reference potential VTT. In a data communication state, the potential amplitude of signals Rx+, Rx− indicative of “0” is V1, and the potential amplitude of signals Rx+, Rx− indicative of “1” is V2 (<V1). In a data non communication state, the potential amplitude of signals Rx+, Rx− is V3. Squelch detection circuit 3 sets squelch signal SQ to “L” level when the potential amplitude of signals Rx+, Rx− is larger than a threshold voltage V4 (<V2), and sets squelch signal SQ to “H” level when the potential amplitude of signals Rx+, Rx− is not more than threshold voltage V4 (>V3).

Receiver 4 is initialized when squelch signal SQ is at “H” level, and outputs a data signal RD in response to signals Rx+, Rx− from input terminals 1, 2 when squelch signal SQ is at “L” level. Reception PLL circuit 5 is initialized when squelch signal SQ is at “H” level, and outputs a clock signal RxCLK in accordance with the transmission speed of output data signal RD of receiver 4 when squelch signal SQ is at “L” level. Switch circuit 6 is made conductive when squelch signal SQ is at “L” level to transmit output clock signal RxCLK of reception PLL circuit 5 to deserializer 7, and is made nonconductive when squelch signal SQ is at “H” level so as not to transmit clock signal RxCLK to deserializer 7. Deserializer 7 operates in synchronization with clock signal RxCLK inputted via switch circuit 6 to convert output data signal RD of receiver 4 into parallel data signals by dividing data signal RD into a predetermined number of data pieces (10 pieces in the figure) and output the resulting signals to data processing circuit 10.

System PLL circuit 8 is inactivated when squelch signal SQ is at “H” level, and generates and outputs a system clock signal SCLK when squelch signal SQ is at “L” level. Transmission/reception control circuit 9 is activated when squelch signal SQ is at “L” level to operate in synchronization with system clock signal SCLK applied from system PLL circuit 8, thereby outputting a control signal C and a reference clock signal CLK to data processing circuit 10 on the basis of the transmission/reception setting signal inputted from outside and also outputting a transmission/reception state signal indicative of the state of the system to outside.

Data processing circuit 10 operates on the basis of control signal C and reference clock signal CLK from transmission/reception control circuit 9 to apply a data processing to the parallel data signals from deserializer 7 and to output the resulting signals as a plurality of bits of reception data (parallel data) to outside. Data processing circuit 10 also applies a data processing to the plurality of bits of transmission data (parallel data) inputted from outside so as to output the resulting data to serializer 13.

Transmission PLL circuit 11 is inactivated when squelch signal SQ is at “H” level, and generates and outputs a clock signal TxCLK when signal SQ is at “L” level. Switch circuit 12 is made conductive when squelch signal SQ is at “L” level, transmits output clock signal TxCLK of transmission PLL circuit 11 to serializer 13, and is made nonconductive when squelch signal SQ is at “H” level so as not to transmit clock signal TxCLK to serializer 13. Serializer 13 operates in synchronization with clock signal TxCLK inputted via switch circuit 12 to convert the parallel data signals from data processing circuit 10 into a set of successive serial data signals TD and to output the resulting signals. Driver 14 is inactivated when squelch signal SQ is at “H” level, and converts serial data signals TD from serializer 13 into clock signals Tx+, Tx− complementary to each other, thereby outputting the resulting signals to output terminal 15, 16 when squelch signal SQ is at “L” level.

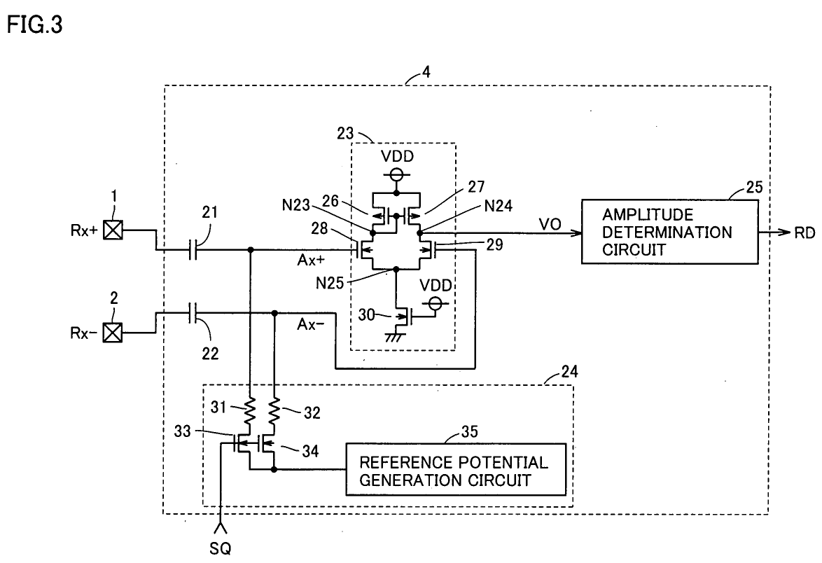

Hereinafter, description will be given of a method for initializing receiver 4 and reception PLL circuit 5, which are features of the communication device. FIG. 3 is a circuit diagram showing the structure of receiver 4. As shown in FIG. 3, receiver 4 includes capacitors 21, 22, a differential amplification circuit 23, an initialization circuit 24 and an amplitude determination circuit 25.

Capacitors 21, 22, which are disposed between input terminals 1, 2 and differential amplification circuit 23, remove direct current components from signals Rx+, Rx− inputted to input terminals 1, 2, and transmit only the amplitude components of signals Rx+, Rx− to differential amplification circuit 23.

Differential amplification circuit 23 includes P-channel MOS transistors 26, 27 and N-channel MOS transistors 28 to 30. P-channel MOS transistor 26 is connected between the line of a power supply potential VDD and a node N23, and P-channel MOS transistor 27 is connected between the line of power supply potential VDD and an output node N24. The gates of P-channel MOS transistors 26, 27 are both connected to node N23. P-channel MOS transistors 26, 27 form a current mirror circuit. N-channel MOS transistor 28 is connected between node N23 and a node N25, and N-channel MOS transistor 29 is connected between output node N24 and node N25. The gate of N-channel MOS transistor 28 is connected to input terminal 1 via capacitor 21, and the gate of N-channel MOS transistor 29 is connected to input terminal 2 via capacitor 22. N-channel MOS transistor 30 is connected between node N25 and the line of a ground potential GND, and its gate receives power supply voltage VDD. N-channel MOS transistor 30 forms a resistance element.

N-channel MOS transistor 28 is supplied with a current having a level corresponding to the potential of signal Ax+ appearing at its gate. Since N-channel MOS transistor 28 and P-channel MOS transistor 26 are connected in series and P-channel MOS transistors 26, 27 form a current mirror circuit, MOS transistors 26 to 28 are supplied with the same value of current. On the other hand, N-channel MOS transistor 29 is supplied with a current having a level corresponding to the potential of signal Ax− appearing at its gate.

When signal Ax+ has a potential higher than that of signal Ax−, P-channel MOS transistor 27 is supplied with a current larger than that of N-channel MOS transistor 29, thereby increasing an output potential VO of differential amplification circuit 23. On the other hand, when signal Ax+has a potential lower than that of signal Ax−, P-channel MOS transistor 27 is supplied with a current smaller than that of N-channel MOS transistor 29, thereby decreasing output potential VO of differential amplification circuit 23.

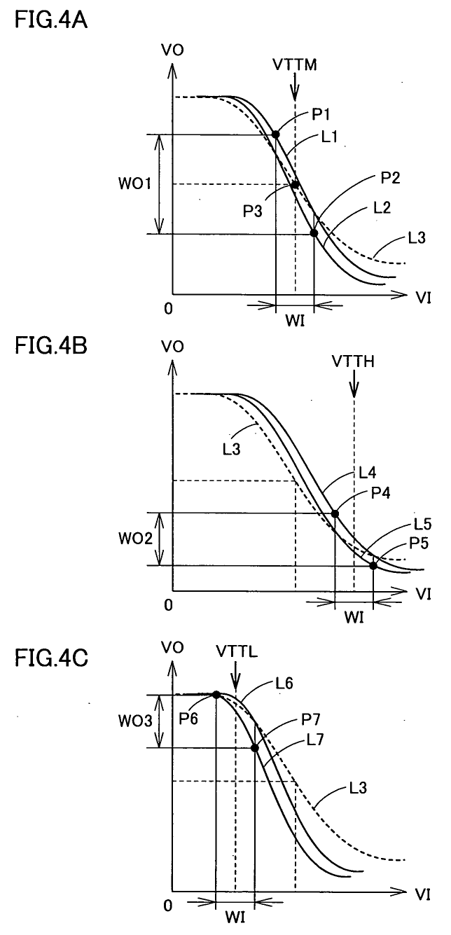

FIGS. 4A, 4B and 4C are diagrams showing the amplification characteristic of differential amplification circuit 23, respectively. In FIGS. 4A, 4B and 4C, input signals Ax+, Ax− of differential amplification circuit 23 are signals fluctuating with a potential amplitude WI at reference potential VTT as a center. The horizontal axis indicates a potential VI of signal Ax− and the vertical axis indicates output potential VO of differential amplification circuit 23. FIG. 4A shows a case where reference potential VTT of signal Ax+, Ax− is optimum; FIG. 4B shows a case where reference potential VTT of signal Ax+, Ax− is too high; and FIG. 4C shows a case where reference potential VTT of signal Ax+, Ax− is too low.

In FIG. 4A, reference potential VTT of signal Ax+, Ax− has an optimum value VTTM. A characteristic curve L1 is a curve indicative of output potential VO with respect to potential VI of signal Ax− in the case where the potential of signal Ax+ is fixed at a maximum value. A characteristic curve L2 is a curve indicative of output potential VO with respect to potential VI of signal Ax− in the case where the potential of signal Ax+is fixed at a minimum value.

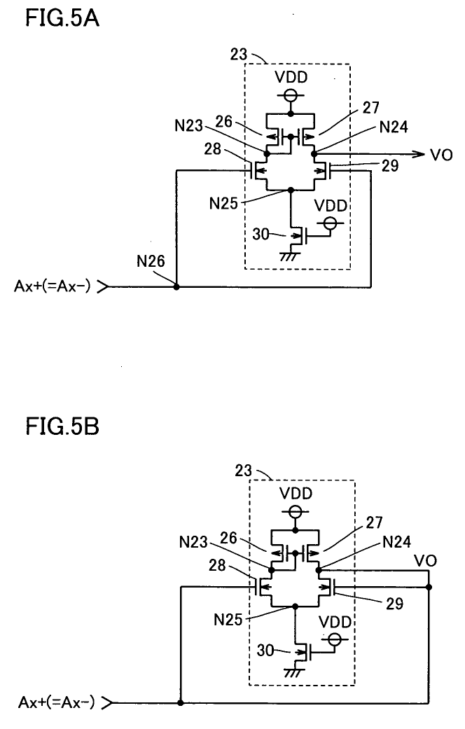

FIG. 5A is a circuit diagram showing the structure of differential amplification circuit 23 in the case where signals Ax+, Ax− have the same potential. In FIG. 5A, the gates of N-channel MOS transistors 28, 29 are both connected to a node N26. The amplification characteristic of differential amplification circuit 23 in this case is represented by a characteristic curve L3 indicated by a broken line in FIG. 4A. When the potentials of signals Ax+, Ax− are low, N-channel MOS transistors 28, 29 are supplied with a smaller current, and P-channel MOS transistors 26, 27 cause a smaller voltage drop, thereby making output potential VO a comparatively high value. When the potentials of signals Ax+, Ax− are high, N-channel MOS transistors 28, 29 are supplied with a larger current, and P-channel MOS transistors 26, 27 cause a larger voltage drop, thereby making output potential VO a comparatively low value.

FIG. 5B is a circuit diagram showing the structure of differential amplification circuit 23 in the case where output potential VO is equal to the potentials of signals Ax+, Ax−. In FIG. 5B, the gates of N-channel MOS transistors 28, 29 are both connected to output node N24. This case is represented by a point P3 on characteristic curve L3.

Since signals Ax+, Ax− are complementary to each other, when Ax+has a maximum potential, Ax− has a minimum potential (point P1), and when Ax+has a minimum potential, Ax− has a maximum potential (point P2). Signals Ax+, Ax− fluctuate between points P1 and P2 at point P3 as a center. Consequently; an amplitude WO1 of output potential VO with respect to potential amplitude WI of signal Ax− becomes the difference between output potential VO at point P1 where potential VI of signal Ax− has a minimum value (signal Ax+has a maximum potential) and output potential VO at point P2 where potential VI of signal Ax− has a maximum value (signal Ax+has a minimum potential).

In FIG. 4B, reference potential VTT of signals Ax+, Ax− has a value VTTH which is higher than VTTM. A characteristic curve L4 is a curve indicative of output potential VO with respect to potential VI of signal Ax− in the case where the potential of signal Ax+ is fixed at its maximum value. A characteristic curve L5 is a curve indicative of output potential VO with respect to potential VI of signal Ax− in the case where the potential of signal Ax+ is fixed at its minimum value. Therefore, an amplitude WO2 of output potential VO with respect to potential amplitude WI of signal Ax− becomes the difference between output potential VO at point P4 where potential VI of signal Ax− has a minimum value (signal Ax+ has a maximum potential) and output potential VO at point P5 where potential VI of signal Ax− has a maximum value (signal Ax+ has a minimum potential). In this case, reference potential VTTM of signals Ax+, Ax− is too high, which makes amplitude WO2 of output voltage VO smaller than amplitude WO1 shown in FIG. 4A and differential amplification circuit 23 have a lower amplification factor.

In FIG. 4C, reference potential VTT of signals Ax+, Ax− has a value VTTL which is lower than VTTM. A characteristic curve L6 is a curve indicative of output potential VO with respect to potential VI of signal Ax− in the case where the potential of signal Ax+ is fixed at its maximum value. A characteristic curve L7 is a curve indicative of output potential VO with respect to potential VI of signal Ax− in the case where the potential of signal Ax+ is fixed at its minimum value. Therefore, an amplitude WO3 of output potential VO with respect to potential amplitude WI of signal Ax− becomes the difference between output potential VO at point P6 where potential VI of signal Ax− has a minimum value (signal Ax+ has a maximum potential) and output potential VO at point P7 where potential VI of signal Ax− has a maximum value (signal Ax+ has a minimum potential). In this case, reference potential VTTL of signals Ax+, Ax− is too low, which makes amplitude WO3 of output voltage VO smaller than amplitude WO1 shown in FIG. 4A and differential amplification circuit 23 have a lower amplification factor.

Again in FIG. 3, in many cases, the potentials of signals Ax+, Ax− inputted to input terminals 1, 2 have a fixed amplitude, but do not have a fixed absolute value in order to cope with reference potential VTT which differs depending on the communication device. Therefore, initialization circuit 24 makes reference potential VTT of signals Rx+, Rx− whose amplitude components are exclusively transmitted by capacitors 21, 22 the value VTTM at which the amplification characteristic of differential amplification circuit 23 becomes optimum.

Initialization circuit 24 includes resistance elements 31, 32, N-channel MOS transistors 33, 34, and a reference potential generation circuit 35. Resistance element 31 and N-channel MOS transistor 33 are connected in series between the gate of N-channel MOS transistor 28 and the output node of reference potential generation circuit 35, whereas resistance element 32 and N-channel MOS transistor 34 are connected in series between the gate of N-channel MOS transistor 29 and the output node of reference potential generation circuit 35. The gates of N-channel MOS transistors 33, 34 both receive squelch signal SQ.

When squelch signal SQ is at “H” level, N-channel MOS transistors 33, 34 are made conductive, and the potential outputted from reference potential generation circuit 35 is applied to the gates of N-channel MOS transistors 28, 29 via N-channel MOS transistors 33, 34 and resistance elements 31, 32. On the other hand, when squelch signal SQ is at “L” level, N-channel MOS transistors 33, 34 are made nonconductive, and only the amplitude components of signals Rx+, Rx− inputted to input terminals 1, 2 are transmitted to differential amplification circuit 23 via capacitors 21, 22. Therefore, in a non data communication state, the potentials of input signals Ax+, Ax− of differential amplification circuit 23 are initialized so as to be the value shown in point P3 of FIG. 4A, and in a data communication state, the potentials of input signals Ax+, Ax− and output potential VO are so controlled as to fluctuate between points P1 and P2 at point P3 as a center, which makes the amplitude characteristic of differential amplification circuit 23 optimum.

Since N-channel MOS transistors 33, 34 are made nonconductive in a data communication state, reference potential generation circuit 35 continues to apply a reference potential to differential amplification circuit 23 in a data communication state so as to attenuate the potential amplitude of input signals Ax+, Ax−, thereby preventing a decrease in the operation margin of differential amplification circuit 23.

Amplitude determination circuit 25 determines whether the amplitude of output potential VO of differential amplification circuit 23 is larger or smaller than the predetermined potential amplitude, and outputs reception data signal RD which is indicative of “0” when the amplitude of output potential VO is larger than the predetermined potential amplitude, and which is indicative of “1” when the amplitude of output potential VO is not more than the predetermined potential amplitude.

Therefore, by providing initialization circuit 24 to receiver 4, a predetermined reference potential is applied to differential amplification circuit 23 in a non data communication state, thereby adjusting differential amplification circuit 23 to an optimum amplification characteristic. In a data communication state, the electrical separation of reference potential generation circuit 35 from differential amplification circuit 23 prevents a decrease in the operation margin of differential amplification circuit 23. Consequently, it becomes possible to realize a communication device capable of making a quick and stable transition from a non data communication state to a data communication state.

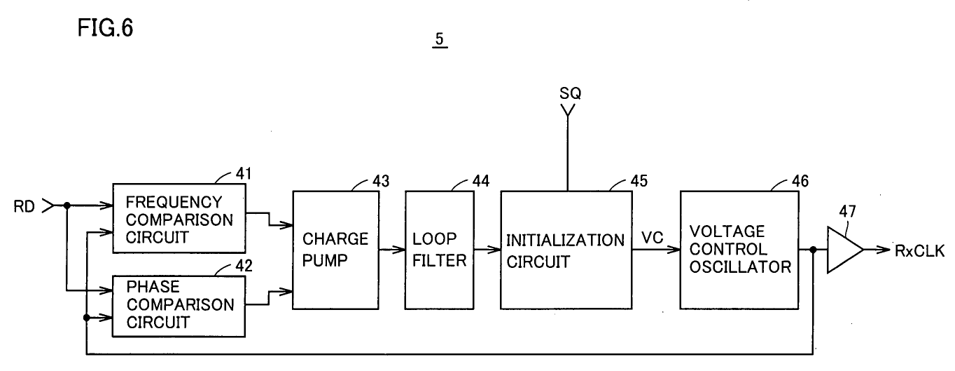

FIG. 6 is a block diagram showing the structure of reception PLL circuit 5 shown in FIG. 1. In FIG. 6, reception PLL circuit 5 includes a frequency comparison circuit 41, a phase comparison circuit 42, a charge pump 43, a loop filter 44, an initialization circuit 45, a voltage control oscillator 46 and a buffer circuit 47.

Reception PLL circuit 5 is a circuit for oscillating voltage control oscillator 46 by applying a feedback control so that the frequency and phase of the output clock signal of voltage control oscillator 46 coincide with the frequency and phase of output data signal RD of receiver 4.

Frequency comparison circuit 41 compares the frequency of output data signal RD of receiver 4 and the frequency of the output clock signal of voltage control oscillator 46, and outputs a frequency difference signal having a pulse width corresponding to the comparison results. Phase comparison circuit 42 compares the phase of output data signal RD of the receiver with the phase of the output clock signal of voltage control oscillator 46, and outputs a phase difference signal having a pulse width corresponding to the comparison results. The charge pump 43 outputs a current which has a polarity and level corresponding to the frequency difference signal from frequency comparison circuit 41 and the phase difference signal from phase comparison circuit 42. Loop filter 44 integrates the output current of charge pump 43 and outputs a control voltage VC. Initialization circuit 45 sets control voltage VC at an initial voltage VCR when squelch signal SQ is at “H” level. Voltage control oscillator 46 outputs a clock signal which has a frequency corresponding to control voltage VC. Buffer circuit 47 buffers the output clock signal of voltage control oscillator 46 and outputs the resulting signal as clock signal RxCLK to outside.

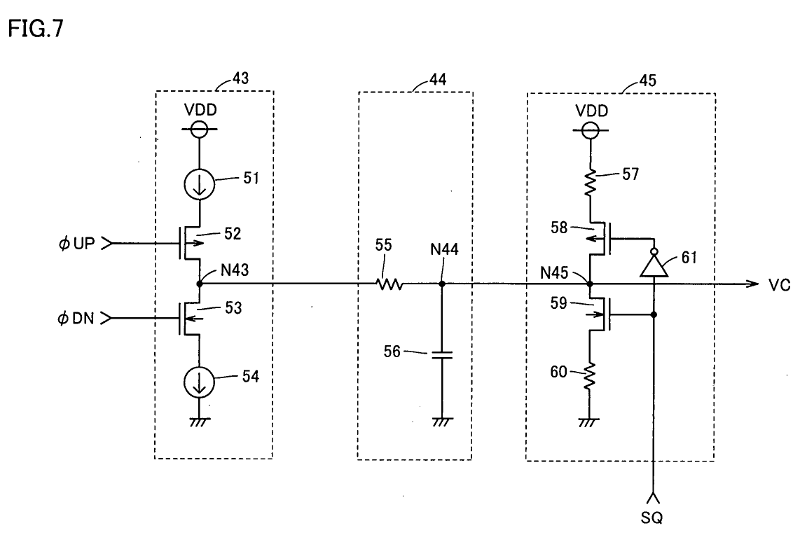

FIG. 7 is a circuit diagram showing the structure of charge pump 43, loop filter 44 and initialization circuit 45. In FIG. 7, charge pump 43 includes constant-current power supply sources 51, 54, a P-channel MOS transistor 52 and an N-channel MOS transistor 53. Constant-current power supply source 51 and P-channel MOS transistor 52 are connected in series between the line of power supply potential VDD and node N43, whereas N-channel MOS transistor 53 and constant-current power supply source 54 are connected in series between node N43 and the line of ground potential GND. The gate of P-channel MOS transistor 52 receives an output signal φUP of frequency comparison circuit 41 and phase comparison circuit 42, and the gate of N-channel MOS transistor 53 receives an output signal φDN of frequency comparison circuit 41 and phase comparison circuit 42.

The frequency and phase of output data signal RD of receiver 4 and the frequency and phase of the output clock signal of voltage control oscillator 46 are compared, e.g. every cycle of data signal RD. When the output clock signal of voltage control oscillator 46 is lower in frequency and later in phase as compared with output data signal RD of receiver 4, signal φUP is set at “L” level only during the time corresponding to the frequency difference and the phase difference. When signal φUP is set at “L” level, P-channel MOS transistor 52 is made conductive so as to flow a current from the line of power supply potential VDD to node N43 via constant-current power supply source 51 and P-channel MOS transistor 52. When the output clock signal of voltage control oscillator 46 is higher in frequency and earlier in phase as compared with output data signal RD of receiver 4, signal φDN is set at “H” level only during the time corresponding to the frequency difference and the phase difference. When signal φDN is set at “H” level, N-channel MOS transistor 53 is made conductive so as to flow a current from node N43 to the line of ground potential GND via P-channel MOS transistor 53 and constant-current power supply source 54.

Loop filter 44 includes a resistance element 55 and a capacitor 56. Resistance element 55 is connected between node N43 and a node N44, and capacitor 56 is connected between node N44 and the line of ground potential GND. When signal φUP is at “L” level, a current flows from the line of power supply potential VDD to capacitor 56 via constant-current power supply source 51, P-channel MOS transistor 52 and resistance element 55 so as to charge capacitor 56. When signal φDN is at “H” level, a current flows from capacitor 56 to the line of ground potential GND via resistance element 55, P-channel MOS transistor 53 and constant-current power supply source 54 so as to discharge capacitor 56. The terminal voltage of capacitor 56 is set at control voltage VC.

Initialization circuit 45 includes resistance elements 57, 60, a P-channel MOS transistor 58, an N-channel MOS transistor 59 and an inverter 61. Resistance element 57 and P-channel MOS transistor 58 are connected in series between the line of power supply potential VDD and a node N45, whereas N-channel MOS transistor 59 and resistance element 60 are connected in series between node N45 and the line of ground potential GND. Squelch signal SQ is inputted to the gate of P-channel MOS transistor 58 via inverter 61, and also inputted directly to the gate of N-channel MOS transistor 59.

When squelch signal SQ is a “L” level, P-channel transistor 58 and N-channel transistor 59 are made nonconductive so as to make output control voltage VC of loop filter 44 be transmitted as it is to voltage control oscillator 46. When squelch signal SQ is at “H” level, P-channel transistor 58 and N-channel transistor 59 are made conductive, which makes control voltage VC initial voltage VCR (VDD/2, for example) which is obtained by dividing power supply voltage VDD by resistance elements 57, 60.

Voltage control oscillator 46 outputs a clock signal having a frequency corresponding to output control voltage VC to buffer circuit 47, and also outputs to frequency comparison circuit 41 and phase comparison circuit 42. When control voltage VC increases, the output clock signal of voltage control oscillator 46 has a higher frequency, and when control voltage VC decreases, the output clock signal of voltage control oscillator 46 has a lower frequency.

Thus, reception PLL circuit 5 compares the frequency and phase of the output clock signal of voltage control oscillator 46 with the frequency and phase of the output data signal RD of receiver 4, and when the output clock signal of voltage control oscillator 46 is lower in frequency and later in phase, operates to increase the frequency of the output clock signal. On the other hand, when the output clock signal of voltage control oscillator 46 is higher in frequency and earlier in phase as the result of the comparison between the frequency and phase of the output clock signal of voltage control oscillator 46 and the frequency and phase of the output data signal RD of receiver 4, reception PLL circuit 5 operates to decrease the frequency of the output clock signal. As a result, clock signal RxCLK outputted from reception PLL circuit 5 is so adjusted to have the same frequency and phase as output data signal RD of receiver 4.

Since reception PLL circuit 5 is not provided with initialization circuit 45 in the conventional communication device, output control voltage VC of loop filter 44 becomes unstable in a non data communication state in which data signal RD is not inputted, thereby making the frequency and phase of the output clock signal of voltage control oscillator 46 unstable. Furthermore, since output control voltage VC of loop filter 44 drops to 0 V when power is off, when power is turned on and reception PLL circuit 5 starts to operate, output control voltage VC is gradually increased from 0 V until it reaches the desired voltage. This takes a long time to make the frequency and phase of output clock signal RxCLK of reception PLL circuit 5 coincide with the frequency and phase of output data signal RD of receiver 4.

In contrast, providing reception PLL circuit 5 with initialization circuit 45 enables voltage control oscillator 46 to have predetermined control voltage VC in a non data communication state, thereby preventing the frequency and phase of the output clock signal of voltage control oscillator 46 from becoming unstable. In addition, at the time of making a transition from a non data communication state to a data communication state, a shorter time is required to make the frequency and phase of output clock signal RxCLK of reception PLL circuit 5 coincide with the frequency and phase of reception data signal RD. This realizes a communication device capable of making a quick and stable transition from a non data communication state to a data communication state.

Second Embodiment

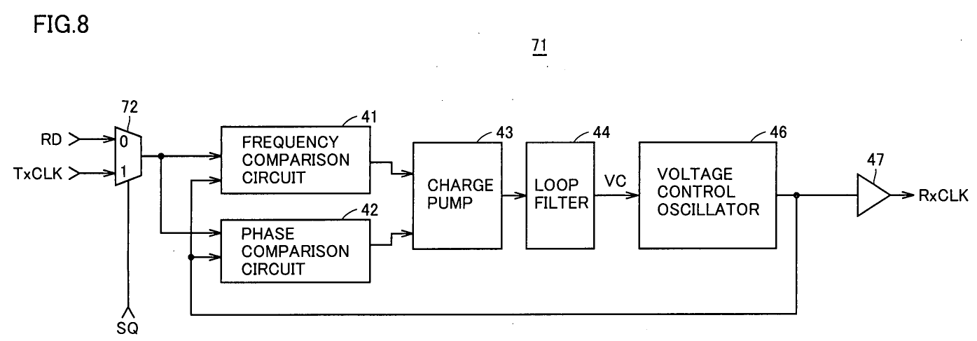

FIG. 8 is a block diagram showing the structure of a reception PLL circuit 71 of the communication device according to a second embodiment of the present invention, and is put in contrast with FIG. 6. Reception PLL circuit 71 shown in FIG. 8 differs from reception PLL circuit 5 of FIG. 6 in that initialization circuit 45 is eliminated and a switching circuit 72 is added.

In FIG. 8, switching circuit 72 receives output data signal RD of receiver 4 and output clock signal TxCLK of transmission PLL circuit 11; selects output data signal RD of receiver 4 when squelch signal SQ is at “L” level; selects output clock signal TxCLK of transmission PLL circuit 11 when squelch signal SQ is at “H” level; and outputs the selected signal to frequency comparison circuit 41 and phase comparison circuit 42. In this case, even when squelch signal SQ is at “H” level, transmission PLL circuit 11 is kept in the activated state.

Thus in the second embodiment, inputting output clock signal TxCLK of transmission PLL circuit 11 in place of output data signal RD of receiver 4 to frequency comparison circuit 41 and phase comparison circuit 42 enables control voltage VC to be kept at a constant value in a non data communication state, thereby preventing the frequency and phase of the output clock signal of voltage control oscillator 46 from becoming unstable. In addition, at the time of making a transition from a non data communication state to a data communication state, a shorter time is required to make the frequency and phase of the output clock signal of reception PLL circuit 71 coincide with the frequency and phase of output data signal RD of receiver 4. This realizes a communication device capable of making a quick and stable transition from a non data communication state to a data communication state.

Modification of Second Embodiment

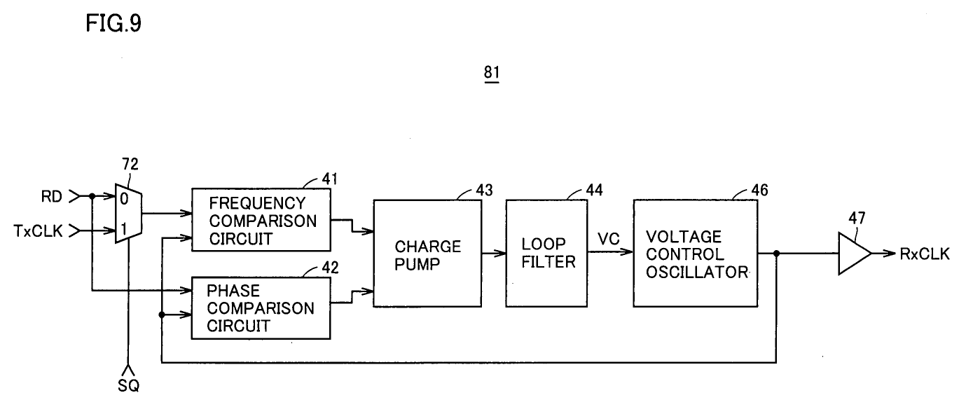

FIG. 9 is a circuit diagram showing the structure of a reception PLL circuit 81 of the communication device according to a modification of the second embodiment of the present invention, and is put in contrast with FIG. 8. Reception PLL circuit 81 shown in FIG. 9 differs from reception PLL circuit 71 of FIG. 8 in that not output data signal RD of receiver 4, but the output signal of switching circuit 72 is inputted to phase comparison circuit 42.

In FIG. 9, switching circuit 72 receives output data signal RD of receiver 4 and output clock signal TxCLK of transmission PLL circuit 11; selects output data signal RD of receiver 4 when squelch signal SQ is at “L” level; selects output clock signal TxCLK of transmission PLL circuit 11 when squelch signal SQ is at “H” level; and outputs the selected signal to frequency comparison circuit 41.

Thus in the modification of the second embodiment, inputting output clock signal TxCLK of transmission PLL circuit 11 in place of output data signal RD of receiver 4 to frequency comparison circuit 41 in a non data communication state prevents the frequency and phase of the output clock signal of voltage control oscillator 46 from becoming unstable. In addition, at the time of making a transition from a non data communication state to a data communication state, a shorter time is required to make the frequency and phase of the output clock signal of reception PLL circuit 81 coincide with the frequency and phase of output data signal RD of receiver 4. This realizes a communication device capable of making a quick and stable transition from a non data communication state to a data communication state.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A communication device for performing communication using a first and second clock signals complementary to each other, comprising:
a squelch detection circuit for determining the communication device as being in a data communication state to output a first signal when said received first and second clock signals have a potential amplitude larger than a predetermined value, and for determining the communication device as being in a non data communication state to output a second signal when said first and second clock signals have a potential amplitude not more than said predetermined value; and
an initialization circuit for initializing said communication device when the second signal is outputted from said squelch detection circuit.

2. The communication device according to claim 1, further comprising:
a receiver for regenerating a data signal on the basis of said received first and second clock signals, wherein
said receiver includes:
first and second capacitors having electrodes receiving said first and second clock signals, respectively; and
a differential amplification circuit including first and second transistors having gates connected to another electrodes of said first and second capacitors and having first electrodes connected to each other, respectively, and amplifying the potential difference in the gates of said first and second transistors, and
said initialization circuit sets the potentials of the gates of said first and second transistors to predetermined potentials when the second signal is outputted from said squelch detection circuit.

3. The communication device according to claim 1, further comprising:
a receiver for regenerating a data signal on the basis of said received first and second clock signals; and
an internal clock generation circuit for outputting an internal clock signal in synchronization with said data signal generated by said receiver, wherein
said internal clock generation circuit includes:
a frequency comparison circuit for comparing the frequency of said data signal with the frequency of said internal clock signal, and outputting a frequency difference signal according to comparison results;
a phase comparison circuit for comparing the phase of said data signal with the phase of said internal clock signal, and outputting a phase difference signal according to comparison results;
a charge pump for selectively outputting a positive current or negative current in response to said frequency difference signal and said phase difference signal;
a loop filter including a capacitor for accumulating the output current of said charge pump to output a control voltage; and
a voltage control oscillator for outputting a clock signal having a frequency according to said control voltage, as said internal clock signal, and
said initialization circuit sets said control voltage to a predetermined value when the second signal is outputted from said squelch detection circuit.

4. The communication device according to claim 3, wherein
said initialization circuit includes:
first and second resistance elements each having a predetermined resistance value; and
a switching circuit for connecting said first resistance element between the line of a power supply potential and an output node of said loop filter, and also connecting said second resistance element between the line of a reference potential and the output node of said loop filter when the second signal is outputted from said squelch detection circuit.

5. The communication device according to claim 3, wherein
said initialization circuit includes:
a switching circuit for applying said data signal to said frequency comparison circuit and said phase comparison circuit when the first signal is outputted from said squelch detection circuit, and applying a reference clock signal having a predetermined frequency to said frequency comparison circuit and said phase comparison circuit when the second signal is outputted from said squelch detection circuit.

6. The communication device according to claim 3, wherein
said initialization circuit includes:
a switching circuit for applying said data signal to said frequency comparison circuit when the first signal is outputted from said squelch detection circuit, and applying a reference clock signal having a predetermined frequency to said frequency comparison circuit when the second signal is outputted from said squelch detection circuit.
